(19) United States
(12) Patent Application Publication
(10) Pub. No.: US 2007/0234513 A1
(43) Pub. Date: Oct. 11, 2007

(54) Hinging device

(75) Inventors: Youfa Luo, Taipei (TW); Yung-Chi Yang, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/396,047

(22) Filed: Mar. 30, 2006

(51) Int. Cl. E05D 11/00

(52) U.S. Cl. 16/223

(57) ABSTRACT

A hinging device for jointing a main body and a display unit of an electronic device is proposed. The hinging device includes a first coupling element coupled to the main body, a second coupling element coupled to the display unit, and a connecting element. The connecting element is formed with a first pivot member, a second pivot member, and a cable holding member. The first and second pivot members are coaxially disposed and pivotally connected to the first and second coupling elements respectively. The cable holding member, interposed between the first and second pivot members, holds at least one cable for connecting the main body and the display unit so as to protect the cable from damage due to rotation of the hinging device.

### FIELD OF THE INVENTION

The present invention relates to hinging devices, and more particularly, to a hinging device for jointing a main body and a display unit of an electronic device together.

### BACKGROUND OF THE INVENTION

A hinging device hinges two objects together so that one can swing relative to the other while being coupled to each other by means of the hinging device. Hinging devices in wide use are, namely hinges for swing doors (also known as “top and bottom bolts”), hinges for swing lids, and hinges for the main bodies and display units of notebook computers.

Compact and versatile, notebook computers are the most popular portable computers nowadays.

In general, portable computers have been through three stages: portables, laptops, and notebooks—characterized by ever-increasing functions as well as ever-decreasing weight and thickness. At present, most 12-inch ultra-thin notebook computers available on the market are less than 2 cm thick, indicating that the current trend in computer technology is towards miniaturization.

In the eyes of notebook computer manufacturers, an important means to downsize a notebook computer lies in integrating all its components and parts a new and designing the compression of the space occupied by its parts. Inevitably, the aforesaid means has negative effects upon the internal structure of notebook computers, most notably in hinge size and mechanical strength.

Users typically switch on and turn off notebook computers and other types of portable computers very often, thus a high standard of hinge size and mechanical strength is essential to the normal functioning of notebook computers despite the frequent repetitious switching thereof. On the other hand, smaller hinges are conducive to miniaturization of notebook computers. Related hinge technologies are disclosed in Taiwanese Patent Nos. 242741 and 489263.

Taiwanese Patent No. 242741 discloses a hinge structure characterized by two rotating shafts as well as a notebook computer equipped with the hinge structure. The hinge structure, through which an internal cable is routed, is intended for an electronic device having a first assembly and a second assembly. The hinge structure comprises a base installed on the first assembly and provided with both a shaft and a positioning bore, a rotation member penetrated by the shaft and rotably installed on the base, a pivot connected to the rotation member and the second assembly respectively, and a positioning assembly installed in the rotation member by resting on the base. The second assembly vertically rotates relative to the first assembly by means of the pivot, whereas the second assembly horizontally rotates relative to the first assembly by means of the rotation member, so as to lock the positioning assembly in the positioning bore as soon as the rotation member rotates a default angle relative to the base.

Nonetheless, such conventional technology has its drawbacks. First, as a result of the rotation of the hinge structure, the internal cable is pulled and damaged, thus reducing product reliability. Second, too many constituent members are required, and individual members are so complicated that they are expensive and bulky. Thirdly, with so many elements used, an assembling process is intricate, lengthy and laborious, and in consequence not only is the assembling process inefficient, but both the assembly cost and the maintenance cost are increased, to the detriment of the industrial use of the hinge structure.

Taiwanese Patent No. 489263 discloses a hinge applicable to notebook computers. The hinge connects a main body and a display unit of a notebook computer with free rotation, and it comprises a body fixed to the main body and equipped with a horizontally extended cylindrical hollow member, a shaft with one end fixed to the display unit and the other end connected to the body with free rotation, and a friction ring interposed between the shaft and the cylindrical hollow member of the body.

The known technology reflects the importance attached to the enhancement of the mechanical strength and durability of a hinge, but it does not efficiently reduce the damage done to an internal cable by a rotating hinge in the face of the trend towards miniaturization, not to mention that the problems with prior art, namely complicated structure, high costs, bulkiness, and complicated assembling processes, remain unsolved, to the detriment of the industrial use of the hinge structure.

Accordingly, it is extremely important for the industry to develop a simple hinge structure that spares an internal cable the rotation-induced damage, facilitates miniaturization, allows for ample wiring space and enhances product reliability with a view to increasing its potential for industrial use and solving various problems exiting in prior art.

### SUMMARY OF THE INVENTION

In view of the drawbacks of the aforementioned conventional technology, a primary objective of the present invention is to provide a hinging device that protects a cable against rotation-induced damage.

Another objective of the present invention is to provide a hinging device conducive to miniaturization.

Yet another objective of the present invention is to provide a hinging device that enhances product reliability.

In order to achieve the above and other objectives, a hinging device applicable to the main body and the display unit of an electronic device is provided according to the present invention. The hinging device comprises a first coupling element coupled to the main body, a second coupling element coupled to the display unit, and a connecting element provided with a first pivot member, a second pivot member and a cable holding member. The first and second pivot members share a common axis and are pivotally connected to the first and second coupling elements respectively. The cable holding member, interposed between the first and second pivot members, holds at least one cable connecting the main body and the display unit. In so doing, the present invention protects the cable from damage arising out of the rotation of the hinging device.

The aforesaid connecting element comprises a first side and a second side that are parallel. The first and second pivot members are coaxially installed on the first and second sides respectively. The cable holding member is interposed between the first and second sides. In a preferred embodiment, the first and second pivot members are, for example, protruding portions coaxially installed on the first and second sides respectively. In another preferred embodiment, the first and second pivot members are, for example, through-hole portions coaxially installed on the first and second sides respectively.

The cross section of the connecting element is preferably, but not limited to, U-shaped. The first coupling element is equipped with a through-hole portion corresponding to the first pivot member, whereas the second coupling element is equipped with a through-hole portion corresponding to the second pivot member. The first coupling element is equipped with at least one coupling cavity for being coupled with a fastening element, so as to couple the first coupling element to the main body, whereas the second coupling element is equipped with at least one coupling cavity for being coupled with a fastening element, so as to couple the second coupling element to the display unit. The fastening element may be a bolt.

The present invention proposes a hinging device wherein a connecting element is provided with a cable holding member intended to make good use of available space and streamline the wiring such that an internal cable is free of any pull when the hinging device rotates, thus protecting the cable against any damage arising out of the rotation of the hinging device, and simplifying the structure for protecting the cable against damage. In the present invention, with the exception of the cable holding member, the connecting element is made as large as possible to meet the strength requirements without introducing any new element. Furthermore, compared to the conventional technology, the present invention employs far less elements to have a shorter assembly time and an easier assembly so as to reduce structure cost, assembly cost and maintenance cost. Last but not least, the hinging device of the present invention protects a cable against any damage arising out of the rotation of the hinging device so as to enhance product reliability and increase its industrial value.

### BRIEF DESCRIPTION OF THE DRAWINGS

FIG. 1A is a schematic diagram of a hinging device according to a preferred embodiment of the present invention;

FIG. 1B is a schematic diagram of a hinging device, viewed from a different perspective, according to a preferred embodiment of the present invention;

FIG. 2 is an exploded view of a hinging device applied in the main body and display unit of an electronic device, showing an exposed cable, according to the preferred embodiment of the present invention; and

FIG. 3 is an exploded view of a hinging device applied in the main body and display unit of an electronic device, showing an enveloped cable, according to the preferred embodiment of the present invention.

### DETAILED DESCRIPTION OF THE PREFERRED EMBODIMENTS

The following specific embodiments are provided to illustrate the present invention. Others skilled in the art will readily understand other advantages and functions of the present invention in accordance with the contents disclosed in this specification. The present invention can also be performed or applied by other different embodiments. Various modifications and changes based on different viewpoints and applications can be made in the details of the specification without departing from the scope of the present invention.

It should be noted that all the diagrams are simple schematic diagrams intended to schematically describe the basic structure of the present invention. Hence, in the diagrams, only those components related to the present invention are numbered, and the shown components are not drawn according to their actual quantity, shape and dimensions when implemented; in practice, the specifications and dimensions of the components are selectively devised indeed, and the layout of the components may be far more intricate.

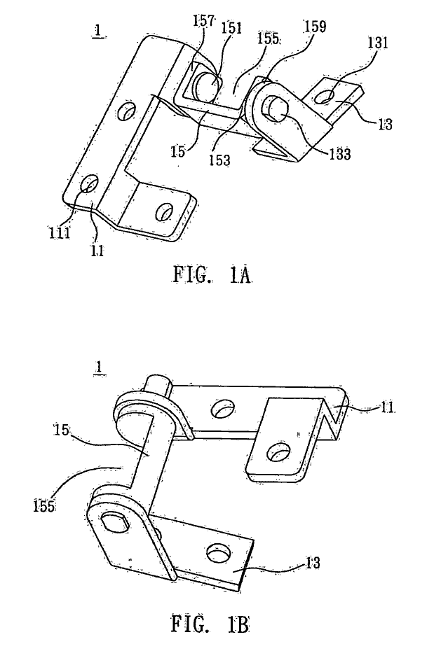

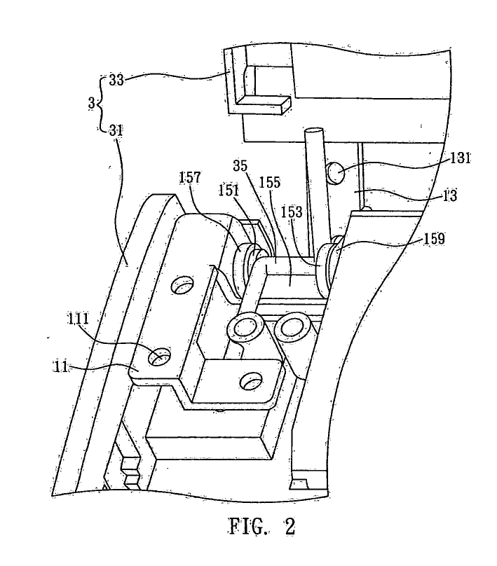

Referring to FIGS. 1A and 1B, which are schematic diagrams of a hinging device 1 of a preferred embodiment according to the present invention, the hinging device 1 comprises a first coupling element 11, a second coupling element 13, and a connecting element 15. Referring to FIG. 2, which is a schematic diagram showing the hinging device 1 for pivotally connecting a main body 31 and a display unit 33 of an electronic device 3 according to the present embodiment, the electronic device referred to may be, for example, a notebook computer, a handy personal computer (HPC), or any other electronic device whose main body and display unit are pivotally connected by a hinge. It should be noted that as the structures and operating principles of notebook computers, handy personal computers, other electronic devices, as well as main bodies and display units thereof, are well-known and thereby are not further described hereinafter.

Referring to FIGS. 1A and 2, the present invention provides a hinging device 1, wherein the first coupling element 11 is coupled to the main body 31. In the present embodiment, the first coupling element 11 comprises at least one coupling cavity 111 for being coupled with a fastening element (not shown), so as to couple the first coupling element 11 to the main body 31. It should be noted that, although the coupling cavity 111 of the present embodiment is a round through-hole, changes can be made to the shape of the through-hole to match with the corresponding coupling element. Furthermore, allocation of the coupling cavity 111 is not to be limited by the descriptions of the present embodiment, as far as quantity and location are concerned, thus those who are skilled in the art may change or modify the present embodiment if necessary.

The second coupling element 13 is coupled to the display unit 33. In the present embodiment, the second coupling element 13 has at least one coupling cavity 131 for being coupled with a fastening element (not shown), so as to couple the second coupling element 13 to the display unit 33. Similarly, installation of the coupling cavity 131 is not to be limited by the descriptions of the present embodiment, as far as shape, quantity and location are concerned; allocation of the coupling cavity 131 will be warranted as long as the coupling cavity matches the fastening elements and enables the coupling element 13 to be coupled to the display unit 33. Furthermore, the fastening element is, for example, a bolt or any other equivalent element.

The connecting element 15 comprises a first pivot member 151, a second pivot member 153, and a cable holding member 155 interposed between the first pivot member 151 and the second pivot member 153. The first pivot member 151 and the second pivot member 153 are pivotally connected to the first coupling element 11 and the second coupling element 13 respectively. The cable holding member 155 holds a cable 35 connecting the main body 31 and the display unit 33 and aligned with an axis of the first pivot member 151. In so doing, the present invention protects the cable 35 from damage due to the rotation of the hinging device 1.

In the present embodiment, the connecting element 15 has a first side 157 and a second side 159 that are parallel, the first pivot member 151 and the second pivot member 153 that are coaxially installed on the first side 157 and the second side 159 respectively, and the cable holding member 155 that is interposed between the first side 157 and the second side 159. In the present embodiment, the first pivot member 151 and the second pivot member 153 are protruding portions coaxially installed on the first side 157 and the second side 159 respectively. Further, the first coupling element 11 and the second coupling element 13 have through-hole portions 133 (as shown in FIG. 1A which illustrates the through-hole portion 133 of the second pivot member 153 but not the other) corresponding to the first pivot member 151 and the second pivot member 153 respectively. The first pivot member 151 and the second pivot member 153, exemplified as the protruding portions, are expanded and secured after passing through the through-hole portions 133, by a process like stamping. In addition, in other embodiments, the first pivot member 151 and the second pivot member 153 may be selectively the through-hole portions, or other equivalent structures, coaxially installed on the first side 157 and the second side 159, whereas the first coupling element 11 and the second coupling element 13 are equipped with the protruding portions corresponding to the first pivot member 151 and the second pivot member 153, however, such pivoting can also be achieved by means of another pivot and thereby is not limited to what is disclosed in the accompanying drawings of the present embodiment.

The cross section of the cable holding member 155 may be, but not limited to, U-shaped, formed by stamping the connecting element 15. Also, the cross section of the cable holding member 155 may form with any kind of recess that allows the cable holding member 155 to hold at least one cable 35 aligned with the axis of the first pivot member 151. Besides, stamping techniques are considered prior art and thus are not further described hereinafter. Fabrication of the cable holding member 155 may also be carried out by means of sheet metal work or any other known technique that has an equivalent effect, rather than in a way limited to the present embodiment.

Moreover, it is also feasible to fabricate the cable holding member 155 by other processing techniques. In the present embodiment, the cable holding member 155 provides maximum room for wiring such that, once a assembling process is completed, the cable holding member 155 holds at least one cable 35 connecting the main body 31 and the display unit 33 and aligned with the axis of the first pivot member 151. The cross sectional shape of the cable holding member 155 is not limited to the one shown in the accompany drawings of the present embodiment; instead, it is subject to changes. In other words, the cross-sectional shape of the cable holding member 155 may be selectively semicircular, V-shaped, W-shaped, or any shape that allows the cable holding member 155 to hold at least one cable 35 aligned with the axis of the first pivot member 151. As the foregoing modifications would be understood by those skilled in the art to make appropriate changes, it does not need to be further described hereinafter.

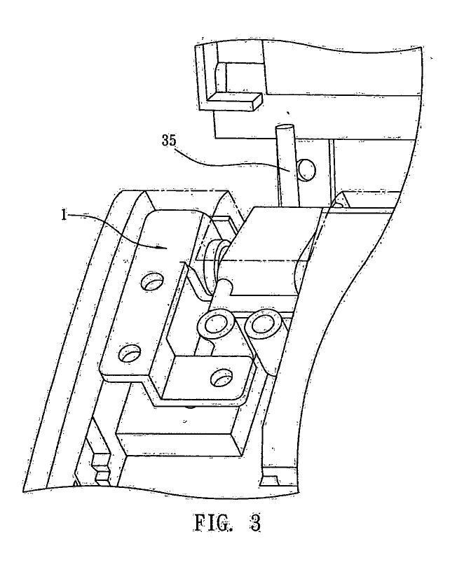

Referring to FIG. 2, which shows the hinging device 1 for the main body 31 and the display unit 33 of the electronic device 3 according to the present embodiment, the first coupling element 11 is coupled to the main body 31, the second coupling element 13 is coupled to the display unit 33, and the cable 35 connected to the main body 31 and the display unit 33 is aligned with the axis of the first pivot member 151 by means of the cable holding member 155 of the connecting element 15. Accordingly, as shown in FIG. 3, the wiring of the cable 35 may be directly traced along the connecting element 15 of the hinging device 1 (the connecting element 15 is not shown in the drawings, as it is covered with a securing protective mask), and in consequence the cable 35 will not be pulled even though the hinging device 1 rotates; in other words, wiring layout is designed in such a way that the cable 35 could have spaces for taking a straightforward route and also aligning with the rotational axis of the hinging device 1, so as to protect the cable 35 from any damage due to the rotation of the hinging device 1.

Compared to the conventional technology, the hinging device of the present invention comprises the cable holding member that is installed in the connecting element pivotally connected to the first coupling element and the second coupling element, wherein the cable holding member provides room for wiring the cable and aligns the cable with the rotational axis of the hinging device; given the simple structural design, not only is the cable protected from rotation-induced damage, but it is feasible to streamline the hinging structure built by the conventional technology and thereby solve the drawbacks of the conventional technology. The application of the present invention only requires a simple change of the structure of the connecting element of the hinging device, and hence, compared to its conventional counterparts, the hinging device of the present invention the present invention employs far less elements to have a shorter assembly time and an easier assembly so as to reduce structure cost, assembly cost and maintenance cost, and increase its potential for industrial use. Accordingly, the present invention solves the problems exiting in the prior art.

The invention has been described using exemplary preferred embodiments. However, it is to be understood that the scope of the invention is not limited to the disclosed embodiments. On the contrary, it is intended to cover various modifications and similar arrangement. The scope of the claims therefore should be accorded the broadest interpretation so as to encompass all such modifications and similar arrangements.

What is claimed is:

1. A hinging device for a main body and a display unit of an electronic device, comprising:
a first coupling element coupled to said main body;
a second coupling element coupled to said display unit; and
a connecting element having a first pivot member, a second pivot member, and a cable holding member interposed between said first and second pivot members, wherein said first and second pivot members sharing a common axis are pivotally connected to said first and second coupling elements respectively, and said cable holding member holding at least one cable for connecting said main body and said display unit is aligned with said axis of said first pivot member, so as to protect said cable from damage due to rotation of said hinging device.

2. The hinging device of claim 1, wherein said connecting element comprises a first side and a second side that are parallel, said first and second pivot members being coaxially installed on said first and second sides respectively, and said cable holding member being interposed between said first and second sides.

3. The hinging device of claim 2, wherein said first and second pivot members are protruding portions coaxially installed on said first and second sides respectively.

4. The hinging device of claim 2, wherein said first and second pivot members are through-hole portions coaxially installed on said first and second sides respectively.

5. The hinging device of claim 1, wherein said connecting element has a U-shaped cross section.

6. The hinging device of claim 1, wherein said first coupling element has a through-hole portion corresponding to said first pivot member.

7. The hinging device of claim 1, wherein said second coupling element has a through-hole portion corresponding to said second pivot member.

8. The hinging device of claim 1, wherein said first coupling element has at least one coupling cavity for being coupled with a fastening element so as to couple said first coupling element to said main body.

9. The hinging device of claim 1, wherein said second coupling element has at least one coupling cavity for being coupled with a fastening element so as to couple said second coupling element to said display unit.

10. The hinging device of claim 8, wherein said fastening element is a bolt.

11. The hinging device of claim 9, wherein said fastening element is a bolt.
